(19) United States
(12) Patent Application Publication
(10) Pub. No.: US 2012/0237423 A1
(43) Pub. Date: Sep. 20, 2012

(54) METHOD AND SYSTEM FOR MULTI-STAGE FLUE GAS CLEANING

(76) Inventor: Edward Bialkin, Lebanon, NJ (US)

(21) Appl. No.: 13/051,685

(22) Filed: Mar. 18, 2011

(51) Int. Cl. B01D 53/48; B01J 8/00; B01D 53/68

(52) U.S. Cl. 423/240 R; 423/242.1; 422/187

(57) ABSTRACT

Flue gas processing is described. A circulating dry flue gas desulfurization (DFGD) scrubber is positioned upstream of a wet flue gas desulfurization (WFGD) scrubber. Flue gas temperature and humidity is controlled. Reagent use is monitored and controlled. The DFGD scrubber is controlled without concern for sulfur dioxide absorption and thus reagent utilization is controlled based on the goal of removing one or more of: sulfur trioxide and/or other acid gases. In some embodiments the circulating DFGD scrubber removes the majority of sulfur trioxide, HCL, and/or HF from the flue gas stream supplied to the DFGD scrubber. The DFGD scrubber is followed by the WFGD scrubber that removes sulfur dioxide and mercury, to achieve a high degree of pollutant removal at a low operating cost as compared to some other systems. WFGD scrubber liquid waste is sent to the circulating DFGD scrubber and used for temperature and/or humidity control purposes.

### FIELD OF THE INVENTION

This invention relates to flue gas processing and, more particularly to methods and apparatus for implementing a system for removing sulfur oxides, other acid gases, mercury, and/or particulates from a flue gas stream.

### BACKGROUND OF INVENTION

One of the byproducts of power plants and turbine engines is exhaust gas, commonly known as flue gas. This gas may contain components which are harmful to the environment. The production of flue gas occurs when fuel is combusted, such as in turbines, refinery heaters, steam boilers, etc. Fuels, which produce flue gas when combusted include, coal, oil, natural gas, waste products such as municipal solid waste, petroleum coke, and other carbon-based materials. It is beneficial to the environment to control the levels of pollutants released into the atmosphere by burning such fuels.

Flue gases produced by burning fossil fuels and/or other carbon based combustors often contain large quantities of undesirable products such as sulfur oxides, other acid gases, for example, hydrogen fluoride and hydrogen chloride, mercury, and particulates. Environmental regulations often require that a high proportion of these potentially harmful constituents be removed prior to releasing the flue gas into the atmosphere.

One common approach to processing flue gas involves the use of a wet flue gas desulfurization (WFGD) scrubber to remove sulfur dioxide from the flue gas of a fossil fuel fired combustor. As a co-benefit, a lesser proportion of other acid gases, mercury, and particulates are removed, as well. While a WFGD scrubber can be effective in reducing sulfur dioxide emissions, even in high sulfur coal applications, it is often less effective than desired at removing other pollutants such as acid gases, mercury, and particulates. In a system using a a WFGD scrubber, a wet electrostatic precipitator can be employed downstream of the WFGD scrubber to remove acid mists that escape. However, wet electrostatic precipitators are relatively costly to deploy and use, and require the use of high grade stainless steel components.

Dry flue gas desulfurization methods have been developed in recent years and have been used as an alternative to a WFGD scrubber in applications where low and moderate sulfur coal is used. Dry flue gas desulfurization methods are capable of greater removal of acid gasses other than sulfur dioxide than a WFGD. Dry flue gas desulfurization methods often allow for more efficient use of alkaline reagent than direct injection for removal of acid gasses because of the better temperature control and mixing conditions in the dry desulfurization reactor. Unfortunately, compared to a WFGD, most dry methods of flue gas processing have proven uneconomical at controlling sulfur emissions where high sulfur coal is used due to the relatively inefficient use and high cost of the alkaline reagents. Furthermore, operating the dry scrubbers in a manner that is intended to achieve a desired level of desulfurization can lead to these devices being operated in a manner which is suboptimal with respect to the removal of other acid gases.

It should be appreciated that while WFGD scrubber based systems have benefits over dry systems with regard to high sulfur fuels, the dry flue gas processing techniques have advantages in applications where fuels contain low to moderate levels of sulfur.

Currently, power plants are often built with a particular fuel source in mind. As low sulfur coal and/or other fuel sources become more scarce, power plants and other users of fuel are likely to be faced with less certainty with regard to the ability to obtain a particular fuel at reasonable prices. From a power plant's management perspective, it would be desirable to be able to switch between different grades of coal or other fossil fuels based on market conditions including price, and still be able to reliably meet emissions standards in a cost effective manner. For example, it may be desirable to be able to switch between low sulfur coal and high sulfur coal depending on market conditions without being constrained by the ability to meet emissions restrictions in a cost effective manner.

As should be appreciated from the above discussion, there is need for improved methods of using reagents and other flue gas additives in a cost effective manner to process flue gas to reduce undesirable emissions. While not necessary for all embodiments, it would be desirable for at least some applications if improved flue gas processing methods and apparatus could provide increased flexibility with regard to the levels of sulfur which can be included in fuel while still allowing emissions standards to be satisfied. It would also be desirable if one or more components could be implemented in a cost effective manner, e.g., using lower grade stainless steel than might be required to withstand high chloride environments found in many WFGD scrubbers in use today.

### SUMMARY OF THE INVENTION

The apparatus and methods of the invention are directed to flue gas processing including methods and apparatus for reducing the amount of sulfur, acid gas and/or other pollutants such as mercury in flue gas.

In accordance with the invention, a circulating dry flue gas de-sulfurization (DFGD) scrubber is positioned upstream of a wet flue gas de-sulfurization (WFGD) scrubber. Flue gas temperature and content is monitored and subjected to temperature control at different points in the system. In addition, reagent use is monitored and controlled. The invention is a process that employs a circulating DFGD scrubber adapted to remove one or more of: sulfur trioxide or other acid gases, mercury, and/or particulates. Reagent used by the circulating DFGD scrubber, in some embodiments, is controlled based on sulfur trioxide and/or acid gas reduction goals and/or target levels without regard to sulfur dioxide absorption thereby optimizing reagent utilization to achieve the objective of acid gas reduction. In this manner, reagent use by the circulating DFGD scrubber is not wasted for purposes of de-sulfurization which can be handled more efficiently by the downstream WFGD scrubber.

In some embodiments but not necessarily all embodiments, the circulating DFGD scrubber removes the majority of sulfur trioxide, other acid gases, particulates, and mercury from the fluid gas stream supplied to the circulating DFGD scrubber. The circulating DFGD scrubber is followed by a WFGD scrubber used to remove sulfur dioxide and additional mercury from the flue gas stream to achieve a high degree of pollutant removal at a low operating cost as compared to some other systems. In some embodiments, all or a portion of a WFGD liquid purge stream, e.g., liquid waste stream, produced by the WFGD scrubber is sent to the circulating DFGD scrubber where it is utilized in the process for temperature and/or humidity control purposes. Thus, at least in some embodiments, the need for wastewater treatment and discharge is reduced or avoided as compared to known systems which use a WFGD scrubber.

The methods and apparatus of the present invention offer numerous benefits over various known systems with regard to one or more of the following: efficient and/or cost effective use of reagent materials, reduction in the amount of liquid waste discharged relative to known WFGD systems, reduction in the cost of material required to implement one or more components, and/or greater flexibility in the types and quality of fuel which may be used while still being able to satisfy flue gas pollution regulations.

Additional features and benefits of the present invention are discussed in the detailed description which follows.

### BRIEF DESCRIPTION OF THE DRAWINGS

FIG. 1 illustrates an exemplary system 100 which processes flue gas in accordance with one exemplary embodiment of the present invention.

### DETAILED DESCRIPTION

The methods and apparatus of the present invention for processing a flue gas stream can be used with a wide range of applications and furnace environments. For example, the invention can be used with power plants, incinerators, refineries, or other systems, for example, where turbine engines, heaters, steam boilers, etc. are used.

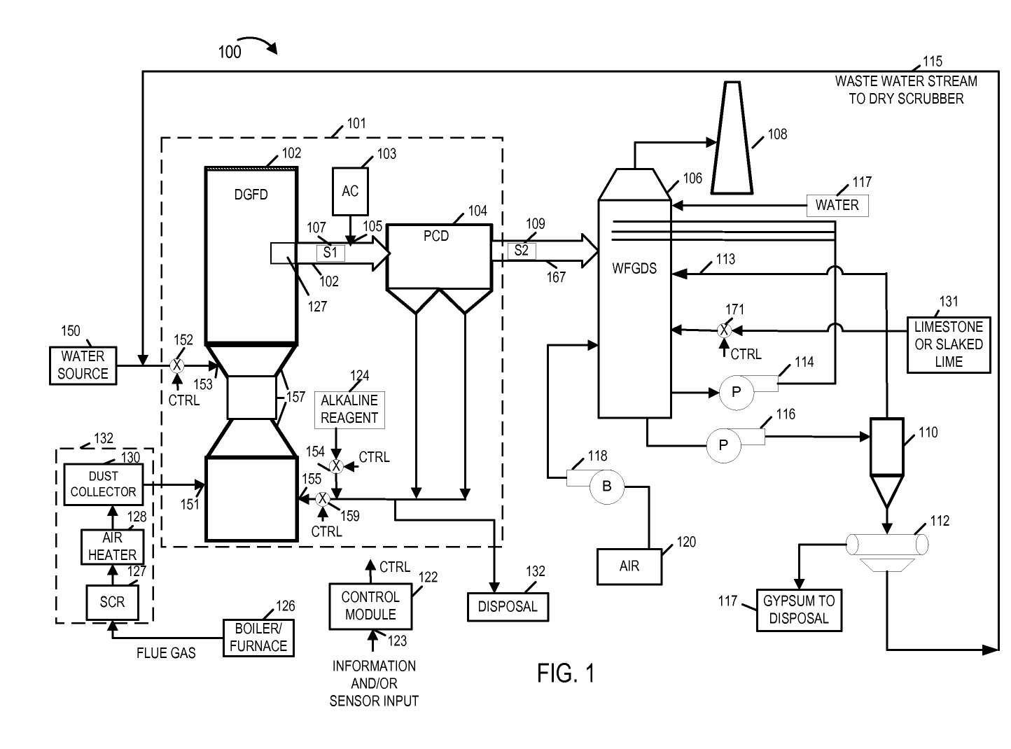

FIG. 1 illustrates an exemplary system 100 implemented in accordance with the present invention. The system shown in FIG. 1 may correspond to, e.g., a power plant. The system 100 comprises a boiler or furnace 126 which produces flue gas as the result of combustion of, e.g., coal, oil or another combustible material.

The furnace 126 is coupled to an optional selective catalytic reduction (SCR) assembly 132 which receives flue gas from the furnace 126 and processes it prior to the flue gas being supplied to a circulating DFGD scrubber 101. The SCR assembly includes an SCR module 127 for performing a selective catalytic reduction process on the flue gas, a flue gas cooler 128 for adjusting flue gas temperature and a dust collector 130 for removing at least some fly ash prior to the flue gas being supplied to the flue gas input 151 of the circulating DFGD scrubber 101. In embodiments where the SCR assembly 132 and/or dust collector 130 are not used, cooled flue gas may be supplied directly to the flue gas input 151 of the circulating DFGD scrubber 101.

The circulating DFGD scrubber 101 includes a circulating DFGD reactor 102, and particulate collection device (PCD) 104 in addition to various control values 152, 154, 159 and various other components as shown in FIG. 1. Control value 152 is used to control, e.g., limit or otherwise regulate the rate at which water, e.g., waste water or a mixture of waste water and fresh water, is introduced into the DFGD reactor 102, e.g., for purposes of temperature control.

Control value 154 serves as a reagent metering device which is configured, in some embodiments to control input of alkaline reagent to the circulating DFGD reactor 102 to produce at least a 50% reduction in sulfur trioxide with respect to the sulfur trioxide level present in the flue gas entering the circulating DFGD reactor 102. In the embodiment shown in FIG. 1, the alkaline reagent 124 is mixed with ash from the PCD 104 prior to being introduced into the DFGD reactor 102. Valve 159 is used to control the introduction of the ash/alkaline reagent mixture into the DFGD reactor 102. The values 152, 154, 159 may be set to deliver material at a fixed rate. However, in some embodiments, values 152, 154 and/or 159 are controlled in a dynamic manner via control module 122 which may, and in some embodiments is, implemented using a general purpose computer and/or hardware. Control module 122 may receive real time sensor inputs and control various values based on the sensor inputs and/or receive information generated from flue gas sample capture operations and lab testing performed on the captured samples. It is expected that as acid gas sensors become readily available, the output of one or more acid gas sensor could provide flue gas acid gas level feedback information to the control module 122 in an automated manner thereby allowing for rapid adjustments in the rate at which alkaline reagent is introduced into the circulating DFGD reactor 102. The rates at which control values 152, 154 and 159 are modified may depend on the rates at which new input information is provided to the control module 122 from sensors or an operator inputting test results. For example, the rate at which valve 152 is controlled may be relatively frequent, e.g., based on real time temperature measurements with the amount of introduced water being varied to maintain a desired temperature in output portion 127 of DFGD reactor 102 or duct 111. Changes to the settings of control values 154, 159 may be less frequent than control valve 102 and may be made based on tests conducted on samples of flue gas entering and/or exiting the DFGD scrubber 101 to detect acid gas levels and/or the level of acid gas reduction being achieved for one or more acid gases. Control module 122 is configured in some embodiments to control a rate at which a reagent such as limestone or slaked lime is input to the wet flue gas desulfurization scrubber 106 to achieve a target sulfur dioxide level in the glue gas output by the wet flue gas desulfurization scrubber 106. The control module may use information indicating a detected sulfur dioxide level in the flue gas input to and/or output from the WFGDS 106 in determining the rate at which limestone or slaked lime is input to the WFGDS 106. The sulfur dioxide level information may be obtained from captured flue gas samples which are tested with the test result information then being supplied to the control module 122. Thus, dynamic control of the rate at which limestone or slaked lime is introduced into the WFGDS 106 is contemplated and supported at least in some embodiments. Accordingly, in at least some embodiments, when a different sulfur dioxide level in said flue gas output by said wet flue gas desulfurization scrubber is indicated to the control module 122 than was previously indicated to said control module 122, the control module may and often will, alter the rate at which limestone or slaked lime is input the WFGDS 106. In this manner the control module 122 may vary the amount of limestone or slaked lime used by the WFGDS 106 from one time period to the next based on sulfur dioxide levels in the flue gas.

The circulating DFGD scrubber 101 is supplied with an alkaline reagent via reagent input 155. In some embodiments, the alkaline reagent supplied by reagent source 124 is a low cost hydrated lime reagent suitable for removal of Hydrochloric (HCL) acid and/or acid gases. While shown inside DFGD scrubber 101, it should be appreciated that alkaline reagent is normally supplied to the DFGD scrubber 101 from alkaline reagent source 124 which may be an external storage device. In some embodiments the reagent is a dry alkaline reagent that is injected as a powder into the circulating DFGD scrubber. Such a reagent can be of considerably lower cost as compared to trona, sodium carbonate, sodium bisulfite, and other, more costly reagents often used in dry direct injection systems. While a lime based reagent is preferred in some embodiments, primarily for cost reasons, the invention does not preclude the use of other reagents such as trona, sodium carbonate, sodium bisulfite, etc. In at least some embodiments somewhere between 50 to 99.9 percent of the sulfur trioxide in the flue gas entering the circulating DFGD scrubber 101 is removed from the flue gas by the circulating DFGD scrubber 101. In some embodiments at least 50 percent of the sulfur trioxide in the flue gas entering the DFGD reactor 102 is removed by the reactor 102. In many embodiments at least 80 percent of the sulfur trioxide entering the DFGD reactor 102 is removed by the DFGD reactor 102 while in still other embodiments at least 90 percent of the sulfur trioxide is removed by the DFGD reactor 102. The same or similar reductions in other acid gases may also be achieved by the DFGD reactor 102 and/or the DFGD reactor in combination with the use of the PCD 104. Thus, the DFGD reactor 102 alone or in combination with PCB 104 can, and in some embodiments does, remove the above discussed percentages of one or more of: i) H₂SO₄, ii) HCL; iii) HFL from the flue gas entering the DFGD scrubber 101. The rate at which reagent is introduced into the DFGD reactor is controlled to achieve the desired rate of sulfur trioxide and/or other acid gases. The control may be achieved by control module 122 controlling one or more the valves/metering devices 154, 159.

The same or similar reduction of other acid gases may be removed by circulating DFGD scrubber 101 along with a portion of any sulfur dioxide present in the flue gas entering the circulating DFGD scrubber 101. In some embodiments but not necessarily all embodiments circulating DFGD scrubber 101 is controlled and operated in a manner which minimizes sulfur dioxide absorption while still removing a majority of sulfur trioxide and other acid gases within the CFBD scrubber 101. In some embodiments the CFBD scrubber 101 has an outlet gas temperature range of 180 F to 240 F (where F standards for degree Fahrenheit) and may be controlled to operate with an internal temperature which is controlled to be in the same or similar temperature range thereby promoting acid gas removal.

Thus, in at least some embodiments, the flue gas is treated utilizing a dry alkaline reagent injected as a powder into the circulating DFGD reactor 102. The injection of the dry alkaline reagent may occur either above or below a venturi section 157 in the circulating DFGD reactor 102. In the FIG. 1 example the injection of the reagent occurs below the venture section 157 via injection port 155.

A water stream for temperature control and humidification, consisting of liquid discharge supplied by a downstream WFDG scrubber 106 and water from a water source 150 (supplied if the source from the WFGD is insufficient for the DFGD process), is injected through control valve 152 into the circulating DFGD reactor 102 into and/or above the venturi section 157 or into a humidification device external to circulating DFGD reactor 102 where it is used to control the level of humidity in alkaline material supplied to the circulating DFGD reactor 102. In embodiments where an external humidifier is used, the humidifier may be located at or in a conduit used to supply alkaline reagent 124 to the DFGD reactor 102. In this manner, the humidifier can mix water with alkaline reagent particles and/or ash mixed with alkaline reagent particles to introduce fluid, e.g, water, into the alkaline reagent and/or ash being supplied to the DFGD reactor 102 and thereby introduce moisture into the flue gas in a controlled manner, e.g., for purposes of temperature control. The introduced water may be, and in some embodiments is, waste water supplied via pipe 115.

The amount of fluid injected via port 153 or introduced via use of a humidifier is performed under control of a control module 122 as a function of the output of sensor assembly module S1 107 and/or a sensor located in the output portion 127 of the DFGD reactor 102. Sensor assembly module S1 107 may include a humidity sensor and/or temperature sensor which provide information to control module 122. Additional sensors in the system such as those included in sensor module S2 109 and located at other locations in the flue gas path also provide information to control module 122 including information on flue gas temperature, humidity, acid gas levels, water flow, etc. The introduction of fluid via port 153 or an external humidifier allows water, e.g., waste water discharged by the WFGD scrubber 106, to be used to control the temperature of the flue gas to keep the flue gas at a particular location in the system 100, e.g., in an outlet portion of the DFGD reactor 102 within a desired temperature range. The outlet portion of the DFGD reactor 102 includes the portion of the DFGD reactor 102 which is coupled to duct 111 to which the PCB 104 is coupled.

By using waste water discharged by the WFGD scrubber 106, supplied via pipe 115, waste fluid is used as a cooling and/or humidity control solution as opposed to being discharged as waste into the environment. The circulating DFGD reactor 102 is used to remove a portion of the acid gases present in the flue gas entering the circulating DFGD reactor 102 prior to the gas being discharged into duct 111. All or some mercury, when present in flue gas entering circulating DFGD scrubber 101, may be removed from the flue gas by the circulating DFGD scrubber 101 and a dry by-product is produced by the DFGD process. As a result of the reaction with the alkaline reagent 124, flue gas output by the circulating DFGD scrubber 101 has a lower chloride content than the flue gas entering the circulating DFGD scrubber 101. Thus, WFGD components downstream of the circulating DFGD scrubber 101 can, and in some are, implemented using components which are less chloride corrosion resistant than would otherwise be required.

In some embodiments, control module 122 controls reagent injection into the circulating DFGD scrubber 101 to achieve a desired level of acid gas reduction or to achieve a desired acid gas level in the flue gas output by the circulating DFGD scrubber 101. The control module 122 controls reagent injection into the circulating DFGD reactor 102 without regard to the amount of sulfur dioxide reduction being achieved by circulating DFGD scrubber 101. This allows the reagent 124 to be used efficiently by the circulating DFGD scrubber 101 for purposes of acid gas reduction while allowing the WFGD scrubber 106 to be primarily responsible for sulfur dioxide reduction. Thus, while the circulating DFGD scrubber 101 may reduce the sulfur dioxide levels in conjunction with the reduction of acid levels in the flue gas, the sulfur dioxide reduction may be viewed as a byproduct of the acid reduction operation for which the control module 122 optimizes the circulating DFGD scrubber 101's temperature, humidity and alkaline reagent levels.

Flue gas exiting the circulating DFGD scrubber 101 is sensed by sensor assembly S1 107 to make sure the desired temperature levels are achieved. The flue gas transported by duct 111 is then filtered by particulate collection device (PCD) 109, to remove fly ash and the dry by-product produced by the circulating DFGD reactor 101 processing performed on the flue gas and to cause further reduction of the acid gases. A fabric filter, dry electrostatic precipitator, or other particulate collection device may be used as PCB device 104 to filter flue gas. A portion of the ash and by-product is collected and discharged as waste via the bins at the bottom of PCD 104. Some of the ash and by-product is fed back and mixed, via control valve 154, with alkaline reagent 124 under the control of control module 122 prior to being injected with the alkaline reagent 124 into the circulating DFGD reactor 102. As the by-product contains some unreacted reagent, this reuse of at least some by-product allows for efficient and relatively complete use of the injected alkaline reagent. Excess fly ash and by-product is sent for disposal as represented by illustration of a disposal device 132 used to discard the excess fly ash and by-product, e.g., as waste. The filtering and by-product removal performed by PCD 104, in some embodiments, causes a further reduction of the acid gases present in the flue gas beyond that achieved by the circulating DFGD reactor 102. Note that to increase the capture of mercury and/or other pollutants, activated carbon (AC) from activated carbon store 103, may be injected via an injection nozzle 105 into the flue gas stream and then removed by PCD device 104 after capturing some or all of the mercury which may be present in the flue gas. While shown in one exemplary injection location, it should be appreciated that activated carbon may be injected into the flue gas stream at another location, e.g., upstream of the circulating DFGD reactor 102 in the system 100 at a location between the SCR assembly 132 and port 151 used to supply flue gas to the DFGD reactor 102.

In accordance with a feature of the invention the WFGD scrubber 106 is positioned in the flue gas stream downstream of the circulating DFGD scrubber 101. Because of its position downstream of the circulating DFGD scrubber 101, the WFGD scrubber 106 is subjected to lower, e.g, controlled, HCL levels as a result of HCL removal by the circulating DFGD scrubber 101. Accordingly, the WFGD scrubber 106 may, and in some embodiments is, implemented using less corrosion resistant materials than is otherwise required.

The WFGD scrubber 106 performs a wet scrubbing operation on the flue gas exiting the circulating DFGD scrubber 101 that it receives via duct 167. This wet scrubbing of the flue gas acts as a polishing step for removal of acid gases, mercury and particulate but also is used to reduce the sulfur dioxide levels of the flue gas to the desired level prior to discharge via smoke stack 108, that is, the WFGD scrubber 106 at least in some but not necessarily all embodiments, removes less acid gas than the circulating DFGD scrubber 101 while making sure that the acid gas levels and sulfur dioxide levels in the flue gas are reduced to levels which will satisfy the emission standard which is applicable. In some but not necessarily all embodiments the WFGD scrubber 106 is controlled to remove 50 to 99 percent of the sulfur oxides remaining in the flue gas after circulating DFGD scrubber 101 processing. The same and/or similar reduction in acid gases may be achieved with respect to acid gases remaining in the flue gas prior to the WFGD scrubbing step.

In various embodiments, the WFGD scrubber 106 adds a lime, limestone or other reagent slurry 131 to the flue gas stream. Air may be injected into the WFGD scrubber via blower 118 to produce gypsum. Pump 114 is used to re-circulate reagent slurry from the bottom of the WFGD scrubber 106 to the top. The reagent reacts with at least a portion of the remaining acid gases present in the WFGD scrubber 106 to produce a wet scrubber by-product that is discharged by the WFGD scrubber 106 in the form of a slurry purge stream via pump 116. The slurry discharged by the WFGD scrubber 106, is processed in a solids/liquid separator such as hydrocyclone 110, and at least a portion of the liquid removed is recycled to the WFGD via pipe 113 with the remainder discharged as waste for control of undesirable fine particles and chlorides. In some embodiments, the concentrated slurry stream from solids/liquid separator 110 is further processed in a second solids/liquid separator such as the vacuum belt filter 112 and the liquid extracted used, to the extent possible, as a liquid input to the circulating DFGD scrubber via pipe 115. In the event that the liquid requirements of the circulating DFGD scrubber are less than the amount extracted by the second solids/liquid separator 112, the excess portion is recycled to the WFGD via pipe 113 and/or discharged as a waste stream, and water source 150 is not required. The solid waste, gypsum 117, produced by the solids/liquids separation process is disposed of.

Thus, as discussed above, in some embodiments, some or all of the liquid purge stream produced from the WFGD scrubber 106 is supplied as an input to the humidifying section of the circulating DFGD scrubber where it is used as liquid that is added to control humidity and/or temperature within the flue gas in the circulating DFGD reactor 102. In this manner, waste water discharge from the WFGD scrubber 106 is minimized, reducing the size of or eliminating the need for costly waste water treatment equipment as compared to systems which do not use the WFGD scrubber waste water as an input to a DFGD scrubber. Waste water and/or other by-product produced by the WFGD scrubber 106 which is not re-injected to control humidity and/or temperature in the flue gas is disposed of.

In some but not necessarily all embodiments, injection of activated carbon upstream of the circulating DFGD scrubber 101 is used to increase mercury capture and removal. In other embodiments injection of activated carbon into the flue gas stream is performed at another position in the flue gas path prior to filtering and ash removal. Thus, in some but not necessarily all embodiments, activated carbon injection is used to enhance capture and removal of mercury and/or other pollutants. Utilization of the WFGD purge stream for circulating fluidized bed dry scrubber temperature control reduces system water consumption as compared to other systems. Furthermore, total particulate and sulfuric acid mist concentrations can be reduced to permit level concentrations without the use of a wet electrostatic participator (WESP) and with lower alkali reagent consumption, thus potentially significantly reducing the capital and operating costs as compared to systems where a WESP and/or alkali injection is used. Thus, in at least some embodiments, use of a WESP is avoided. Another advantage of some embodiments is that the chloride capture which occurs in the circulating DFGD, allows the WFGD to be constructed of less corrosion resistant, lower cost materials.

In view of the above discussion it should be appreciated that numerous variations on the above discussed embodiments are possible while staying within the scope of the invention.

What is claimed is:

1. A pollution control system, comprising:
a circulating dry flue gas desulfurization reactor having a flue gas input for receiving flue gas and a first processed flue gas output for outputting processed flue gas generated by said circulating dry flue gas desulfurization reactor processing received flue gas; and
a wet flue gas desulfurization scrubber coupled to said circulating dry flue gas de-sulfurization reactor, said wet flue gas desulfurization scrubber having a processed flue gas input for receiving flue gas which was previously processed by said circulating dry flue gas de-sulfurization reactor and a second processed flue gas output for outputting flue gas generated by said wet flue gas desulfurization scrubber.

2. The system of claim 1, further comprising:
a control module for controlling the introduction of water into the flue gas being processed to control the temperature in an outlet portion of said circulating dry flue gas desulfurization reactor.

3. The system of claim 2, wherein said control module is configured to control the rate of introduction of water into flue gas passing through said circulating dry flue gas desulfurization reactor to keep the temperature in an outlet portion of said circulating dry flue gas desulfurization reactor in the range of 180 F to 240 F.

4. The system of claim 2, wherein said control module is configured to control said circulating dry flue gas desulfurization reactor to perform at least one acid gas reduction operation without regard to sulfur dioxide reduction.

5. The system of claim 4, wherein said at least one acid gas reduction operation is an operation which reduces the amount of at least one of the following acid gases: i) HCL, ii) HF, iii) SO₃ or iv) H₂SO₄ present in the flue gas.

6. The system of claim 3, further comprising:
a particulate collection device positioned between said circulating dry flue gas desulfurization reactor and said wet flue gas desulfurization scrubber for removing at least some fly ash from the flue gas prior to processing of the flue gas by the wet flue gas desulfurization scrubber.

7. The system of claim 4, wherein said particulate collection device includes at least one of a fabric filter or dry electrostatic precipitator.

8. The system of claim 4, wherein an alkaline reagent metering device is configured to control input of alkaline reagent to said circulating dry flue gas de-sulfurization reactor to produce at least a 50% reduction in at least one of the following acid gases: i) HCL, ii) HF, iii) SO₃ or iv) H₂SO₄ present in the flue gas with respect to the level of said at least one acid gas in the flue gas input to said circulating dry flue gas de-sulfurization reactor.

9. The system of claim 8, wherein said alkaline reagent metering device is configured to control a rate at which alkaline reagent is supplied to said circulating dry flue gas de-sulfurization reactor to produce a reduction in at least one of the following acid gases: i) HCL, ii) HF, iii) SO₃ or iv) H₂SO₄ present in the flue gas of at least 80% with respect to the level of the at least one acid gas in the flue gas input to said circulating dry flue gas de-sulfurization reactor.

10. The system of claim 1, wherein said wet flue gas desulfurization scrubber includes a waste water output, said system further comprising:
a waste water supply line for supplying waste water to a water input of said circulating dry flue gas de-sulfurization reactor.

11. The system of claim 10, further comprising:
a control module configured to control an amount of water input to said circulating dry flue gas de-sulfurization reactor as a function of a target temperature range.

12. The system of claim 2, further comprising:
an activated carbon injector for injecting activated carbon into flue gas as it passes from the first processed flue gas output of said circulating dry flue gas desulfurization reactor and the flue gas input of said wet flue gas desulfurization scrubber or injecting activated carbon into the flue gas as it enters the dry flue gas desulfurization reactor.

13. The system of claim 2, wherein said control module is further configured to control a rate at which limestone or slacked lime is supplied to the wet flue gas desulfurization scrubber to achieve a target sulfur dioxide level in the flue gas output by said wet flue gas desulfurization scrubber.

14. The system of claim 13, wherein said control module alters the rate at which limestone or slacked lime is supplied in response to an input indicating a different sulfur dioxide level in said flue gas output by said wet flue gas desulfurization scrubber than was previously indicated to said control module.

15. A pollution control method, comprising:
receiving flue gas at a flue gas input of a circulating dry flue gas desulfurization reactor;
operating the circulating dry flue gas desulfurization reactor to process flue gas supplied via said flue gas input; and
operating a wet flue gas desulfurization scrubber coupled to said circulating dry flue gas de-sulfurization reactor, to process flue gas previously processed by said circulating dry flue gas de-sulfurization reactor and output the flue gas processed by said wet flue gas desulfurization scrubber.

16. The method of claim 15, further comprising:
controlling the introduction of water into flue gas being processed by said circulating dry flue gas desulfurization reactor.

17. The method of claim 16, wherein controlling the introduction of water into flue gas is performed as a function of a flue gas temperature measurement, the rate of water being introduced into said flue gas being controlled to keep the temperature in an outlet portion of said circulating dry flue gas desulfurization reactor in the range of 180 F to 240 F.

18. The method of claim 16, further comprising:
controlling said circulating dry flue gas desulfurization reactor to perform at least one acid gas reduction operation without regard to sulfur dioxide reduction.

19. The method of claim 18, wherein said at least one acid gas reduction operation is an operation which reduces the amount of at least one of the following acid gases: i) HCL, ii) HF, iii) SO₃ or iv) H₂SO₄ present in the flue gas.

20. The method of claim 17, further comprising:
operating a particulate collection device positioned between said circulating dry flue gas desulfurization reactor and said wet flue gas desulfurization scrubber to removing at least some fly ash from the flue gas prior to processing of the flue gas by the wet flue gas desulfurization scrubber.

21. The method of claim 18, wherein controlling said circulating dry flue gas desulfurization reactor to perform at least one acid gas reduction operation includes controlling an alkaline reagent metering device to supply alkaline reagent to said circulating dry flue gas de-sulfurization reactor at a rate which produces at least a 50% reduction in at least one of the following acid gases: i) HCL, ii) HF, iii) SO₃ or iv) H₂SO₄ present in the flue gas with respect to their level in the flue gas input to said circulating dry flue gas de-sulfurization reactor.

22. The method of claim 15, further comprising:
introducing waste water from said wet flue gas desulfurization scrubber into the flue gas being processed by said circulating dry flue gas de-sulfurization reactor.

23. The method of claim 22, further comprising:
controlling an amount of waste water introduced into the flue gas being processed by said circulating dry flue gas de-sulfurization reactor as a function of a target temperature range.

24. The method of claim 23, further comprising:
injecting activated carbon into flue gas as it passes from said circulating dry flue gas desulfurization reactor and to said wet flue gas desulfurization scrubber or injecting activated carbon into the flue gas as it enters the dry flue gas desulfurization reactor.

25. The method of claim 16, further comprising:
controlling a rate at which limestone or slacked lime is supplied to the wet flue gas desulfurization scrubber to achieve a target sulfur dioxide level in the flue gas output by said wet flue gas desulfurization scrubber.
